(19) United States
(12) Patent Application Publication
(10) Pub. No.: US 2009/0006867 A1
(43) Pub. Date: Jan. 1, 2009

(54) System, device and method for providing data availability for lost/stolen portable communication devices

(75) Inventors: Vinod Choyi, Ottawa (CA); Dmitri Vinokurov, Ottawa (CA)

Correspondence Address: KRAMER & AMADO, P.C., 1725 DUKE STREET, SUITE 240, ALEXANDRIA, VA, 22314, US

(73) Assignee: ALCATEL LUCENT, Paris (FR)

(21) Appl. No.: 11/819,832

(22) Filed: Jun. 29, 2007

(51) Int. Cl. G06F 12/14

(52) U.S. Cl. 713/193; 726/26

(57) ABSTRACT

A system, device and method for providing data availability for a portable communication device, including various combinations of the following steps: notifying an operator that the portable communication device is missing; triggering encryption of data on the portable communication device; sending a data retrieval command to the portable communication device; authenticating the data retrieval command; retrieving data from the portable communication device; identifying a portion of the data retrieved from the portable communication device that is confidential; encrypting the identified confidential data on the portable communication device; and erasing the identified confidential data from the portable communication device or recovering the portable communication device and decrypting the confidential data on the portable communication device.

### BACKGROUND OF THE INVENTION

1. Field of the Invention

This invention relates generally to systems, devices and methods for protecting data in portable communication devices.

2. Description of Related Art

Mobile wireless communication devices such as smart phones and personal data assistants (PDAs) are known. In fact, some consider such devices to be the greatest invention of the last quarter century. Sometimes, portable communication devices contain confidential or otherwise sensitive data. It is desirable to maintain the privacy of confidential and sensitive data contained in a portable communication device.

Unfortunately, portable communication devices containing sensitive data may sometimes be lost and found by a third party for whom the data is not intended and to whom the data should not be available. Further, portable communication devices containing confidential or otherwise sensitive data may sometimes be stolen. In fact, the theft of such a device at times may be an intentional attempt to obtain access in an unauthorized manner to the confidential or sensitive data stored on the portable communication device. Thus, there is a need for systems, devices and methods for protecting data in portable communication devices.

The foregoing objects and advantages of the invention are illustrative of those that can be achieved by the various exemplary embodiments and are not intended to be exhaustive or limiting of the possible advantages which can be realized. Thus, these and other objects and advantages of the various exemplary embodiments will be apparent from the description herein or can be learned from practicing the various exemplary embodiments, both as embodied herein or as modified in view of any variation which may be apparent to those skilled in the art. Accordingly, the present invention resides in the novel methods, arrangements, combinations and improvements herein shown and described in various exemplary embodiments.

### SUMMARY OF THE INVENTION

In light of the present need for systems, devices and methods for protecting data in portable communication devices, a brief summary of various exemplary embodiments is presented. Some simplifications and omission may be made in the following summary, which is intended to highlight and introduce some aspects of the various exemplary embodiments, but not to limit its scope. Detailed descriptions of a preferred exemplary embodiment adequate to allow those of ordinary skill in the art to make and use the invention concepts will follow in later sections.

One exemplary embodiment is a system, device, and method for providing data availability for a portable communication device, including notifying an operator that the portable communication device is missing, sending a data retrieval command to the portable communication device, authenticating the data retrieval command, retrieving data from the portable communication device, identifying a portion of the data retrieved from the portable communication device that is confidential, and erasing the identified confidential data from the portable communication device.

Another exemplary embodiment is a system, device and method for providing data availability for a portable communication device, including notifying an operator that the portable communication device is missing, triggering encryption of data on the portable communication device, identifying confidential data on the portable communication device, encrypting the identified confidential data on the portable communication device, recovering the portable communication device, and decrypting the confidential data on the portable communication device.

A third exemplary embodiment that combines aspects of other exemplary embodiments is a system, device and method for providing data availability for a portable communication device, including notifying an operator that the portable communication device is missing, triggering encryption of data on the portable communication device, identifying confidential data on the portable communication device, encrypting the identified confidential data on the portable communication device, retrieving the identified confidential data from the portable communication device, and erasing the identified confidential data from the portable communication device.

### BRIEF DESCRIPTION OF THE DRAWINGS

In order to better understand various exemplary embodiments, reference is made to the accompanying drawings, wherein:

FIG. 1 is a flowchart of a first exemplary embodiment of a method for providing data availability for lost or stolen portable communication devices;

FIG. 2 is a flowchart of a second exemplary embodiment of a method for providing data availability for a lost or stolen portable communication devices; and

FIG. 3 is a schematic diagram of an exemplary embodiment of a system for providing data availability for lost or stolen portable communication devices.

### DETAILED DESCRIPTION OF THE PREFERRED EMBODIMENTS OF THE INVENTION

The subject matter described herein addresses the problem of availability of confidential or sensitive data from lost or stolen portable communication devices. In various exemplary embodiments, wireless connectivity between the portable communication device and an operator network is utilized after the portable communication device has been lost or stolen. Using such communication connectivity, a legitimate owner of the portable communication device is able to obtain data from the device by using the mobile operator or Internet Service Provider's mobile network after the portable communication device has been lost or stolen.

Subsequently, in various exemplary embodiments, at least confidential or sensitive portions of data on the lost or stolen portable communication device are subjected to a security policy. In various exemplary embodiments, the security policy includes total elimination or corruption of the data on the portable communication device.

In various exemplary embodiments, the portable communication device is a smart phone. A smart phone is a telephone that includes functions found on a personal digital assistant (PDA). For example, a smart phone may have an operating system such as Windows, Linux or Symbian. In other exemplary embodiments, the portable communication device is a PDA. In various exemplary embodiments, the portable communication device includes removable media that carries confidential or sensitive information relevant to the user of the portable communication device or relevant to an enterprise of the user of the portable communication device. In various exemplary embodiments, the portable communication device is a laptop computer.

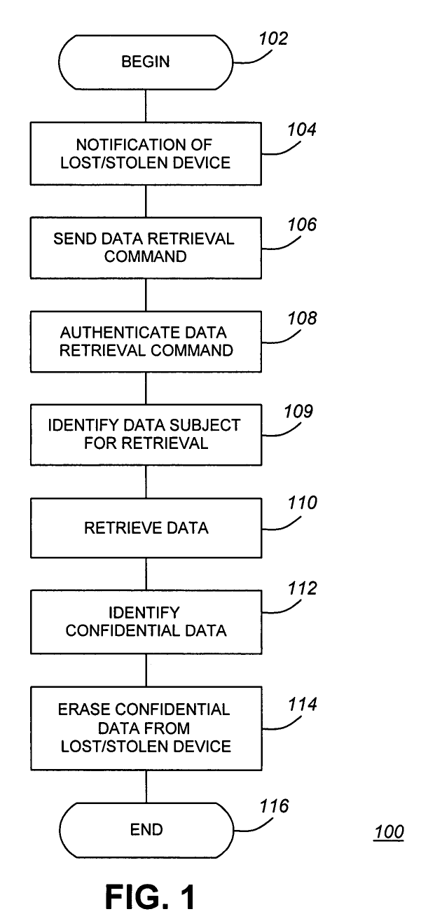

Referring now to the drawings, in which like numerals refer to like components or steps, there are disclosed broad aspects of various exemplary embodiments. FIG. 1 is a flowchart of a first exemplary embodiment of a method 100 for providing data availability for lost or stolen portable communication devices. The method 100 begins in step 102 and continues to step 104.

In step 104, a notification is made that the portable communication device is lost or stolen. This can be as simple as a telephone call made by a mobile telephone server subscriber. Any known means of communication, or later developed means of communication, is used in various exemplary embodiments in order to perform the step of notifying a system operator that a portable communication device has been lost or stolen in step 104.

Following notification that a portable communication device is lost or stolen in step 104, the method 100 proceeds to step 106. In step 106, a data retrieval command is sent to the portable communication device.

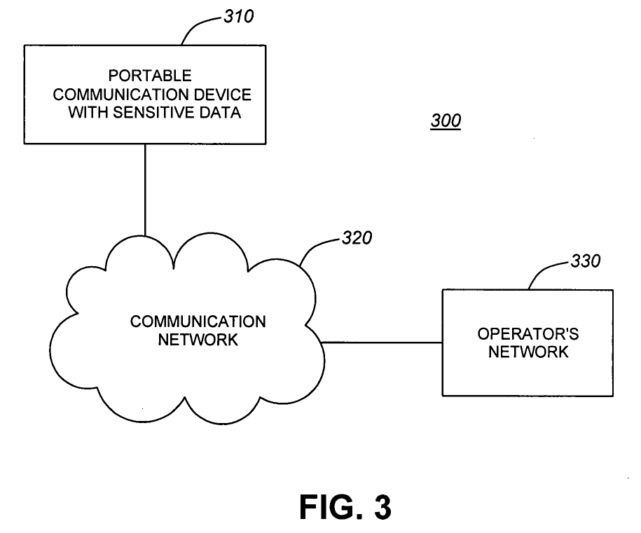

FIG. 3 is a schematic diagram of an exemplary embodiment of a system 300 for providing data availability for lost or stolen portable communication devices. System 300 includes a portable communication device 310, a communication network 320, and an operator's network 330. For the purposes of the subject matter described herein, the portable communication device 310 is believed to include confidential or otherwise sensitive data that is not intended to be available to all persons.

Returning to the first exemplary method 100, and with reference to step 106, the data retrieval command is sent from the operator's network 330 through the communication network 320 to the portable communication device 310. In various exemplary embodiments, the communication network 320 is a radio network or other wireless communications network. Thus, in various exemplary embodiments, the communication network 320 is a cellular telephone network. In still other embodiments, the communication network 320 includes the Internet. It should be apparent that, any currently known or later developed, form of communication network can be implemented in communication network 320.

After the data retrieval command is sent in step 106, the method 100 proceeds to step 108. In step 108, the method 100 authenticates the data retrieval command received by the portable communication device 310.

In various exemplary embodiments, the authentication performed in step 108 is achieved by an attached keyed hash message authentication code (HMAC) block. In various exemplary embodiments, the HMAC block is generated from the entire command with a secret shared by an operator and a subscriber. In various exemplary embodiments, the shared secret is used by an operator for the device or subscriber authentication.

After the data retrieval command is authenticated in step 108, the first exemplary method 100 proceeds to step 109. In step 109, an identification is made of the data on the portable communication device 310 that is subject for retrieval. In some instances, it may be desirable to retrieve all of the data on the portable communication device 310. In many instances, it may be desirable to retrieve only a portion of the data on the portable communication device 310. In step 109, an identification is made of what portions of the data on the portable communication device 310 should be retrieved.

Next, the first exemplary method 100 proceeds to step 110. In step 110, the confidential or otherwise sensitive data stored on a portable communication device 310 is retrieved. It should be apparent that, in connection with step 110, other data may be retrieved from the portable communication device 310, including data that is not confidential or sensitive. Thus, in various exemplary embodiments, an application loaded on the portable communication device 310 is triggered to connect to the operator's network 330 through the communication network 320.

In various exemplary embodiments, the trigger is an external trigger. In other words, in various exemplary embodiments, the trigger is sent by an operator. Conversely, in various exemplary embodiments, the trigger is an internal trigger. When the trigger is an external trigger, in various exemplary embodiments the trigger is authenticated.

In various exemplary embodiments, an internal trigger is a trigger that is generated locally following an identification of a defined security risk event such as loss or theft of the portable communication device 310. In various exemplary embodiments, the triggered portable communication device 310 uploads all of its data that is subject to a particular security policy.

In various exemplary embodiments, retrieval of the data from the portable communication device 310 in step 110 further includes encrypting the data. In various exemplary embodiments, encryption of the data retrieved in step 110 is performed using a public key stored on the portable communication device 310. In various exemplary embodiments, only an authorized officer at the location of the operator's network 330 with possession of the corresponding private key has the ability to decrypt the data transferred from the portable communication device 310 through the communication network 320 in step 110. In various exemplary embodiments, the data is encrypted “on the fly,” that is, while being transferred.

In various exemplary embodiments, the retrieval of the data in step 110 further includes decrypting the data. In various exemplary embodiments, decryption of the data in connection with data retrieval in step 110 is performed using a private key stored at the operator's network 330.

Following step 110, the first exemplary method 100 proceeds to step 112. In step 112, an identification is made on the data retrieved in step 110 to determine what portion of the data is confidential or sensitive. It should be apparent that, in embodiments where all of the data retrieved in step 110 is confidential or sensitive, and where this fact is known, step 112 is unnecessary. In fact, step 112 is unnecessary in other exemplary embodiments as well, as will be described in further detail below.

Following step 112, the first exemplary method 100 proceeds to step 114. In step 114, data is erased from the lost or stolen portable communication device 310. In various exemplary embodiments, the data erased from the lost or stolen portable device 310 in step 114 corresponds to the data identified as confidential in step 112. It should also be apparent that, in various exemplary embodiments, all data is erased from the portable communication device 310 in step 114. In some embodiments, this includes erasure of all data from the lost or stolen portable communication device 310 where step 112 is skipped.

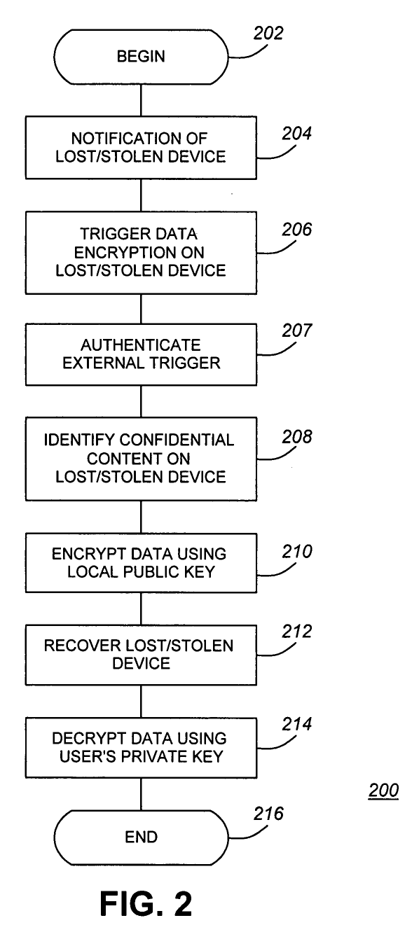

FIG. 2 is a flowchart of a second exemplary embodiment of a method 200 for providing data availability for lost or stolen portable communication devices 310. The second exemplary method 200 begins in step 202 and begins to step 204. Step 204 corresponds to step 104 in the first exemplary method 100.

The second exemplary method 200 then proceeds to step 206. In step 206, data encryption on the portable communication device 310 is triggered. In various exemplary embodiments, encryption of the data on the lost or stolen portable communication device 310 is triggered by sending a signal from the operator's network 330 through the communication network 320 to the portable communication device 310. This is referred to as an external trigger. In step 207, when the trigger is an external trigger, the trigger is authenticated.

In various exemplary embodiments, encryption of the data on the lost or stolen portable communication device 310 is triggered internally. For example, the trigger may be generated from within the portable communication device 310 upon recognized the occurrence of a pre-defined security event. It should be apparent that, when an internal trigger is used in step 206, various exemplary embodiments omit step 207.

Following step 206, (or step 207) the second exemplary method 200 proceeds to step 208. In step 208, the data stored on the portable communication device 310 is evaluated to identify what portions of that data is confidential or otherwise sensitive. In various exemplary embodiments, the identification of confidential content on the lost or stolen portable communication device 310, performed in step 208, includes identifying entire system areas on the portable communication device 310 that are believed to include confidential or sensitive data. It should be apparent that, in various exemplary embodiments, step 208 is skipped.

Following step 208, the second exemplary method 200 proceeds to step 210. In step 210, the data identified as confidential or sensitive in step 208 is encrypted. It should be apparent that, in embodiments where step 208 is skipped, all data on the portable communication device 310 is encrypted in step 210. In various exemplary embodiments, the encryption of data performed in step 210 is performed using a locally stored public key.

Following step 210, the second exemplary method 200 proceeds to step 212. In step 212, the lost or stolen portable communication device 310 is recovered. This includes, for example, finding a lost device 310. The second exemplary method 200 then proceeds to step 214.

In step 214, the encrypted data on the portable communication device 310 is decrypted. In various exemplary embodiments, the decryption in step 214 is performed using the private key corresponding to the public key used for encryption. In various exemplary embodiments, the user's private key is paired with the public key.

In various exemplary embodiments, the user's private key used in connection with step 214 is paired with a local public key used in connection with step 210. In various exemplary embodiments, a user's private-public key pair may be unique for a particular user or group of users.

In some applications, it is believed that the second exemplary method 200 is preferable to the first exemplary method 100. Examples of such scenarios include the situation when there is a chance to retrieve the portable communication device 310. When the portable communication device 310 can be recovered, if data and operating system retrieval from the operator's network 330 to the portable communication device 310 is a time and resource consuming process, it is believed to be preferable to use the second exemplary method 200.

Similarly, in some applications, it may be desirable to secure data stored on the portable communication device 310 as soon as possible. In such instances, a wireless communication channel bandwidth through the communication network 320 might not be sufficient to perform immediate retrieval of confidential data. Other examples of where the second exemplary method 200 is believed to be preferable include applications where a subscriber does not trust an operator and the subscriber keeps the private key as a result of that distrust.

Following decryption of the data in step 214, the second exemplary method 200 proceeds to step 216 where the method 200 ends.

Some implications of the subject matter described herein include the following. In various exemplary embodiments, central management of the portable communication device 310 is achieved at the location of the operator's network 330. This is advantageous where the local data stored on the portable communication device 310 has a high value to a corporation or has a high security profile.

Various exemplary embodiments protect confidential or sensitive data on the portable communication device by blacklisting the device, that is, putting the identity of the mobile subscriber for the device on a lost list when a portable telephone is lost and identified, including by way of a manual identification, blocking access to the portable communication device 310, encrypting data on the portable communication device 310, and corrupting or eliminating data on the portable communication device 310.

In various exemplary embodiments, the second exemplary method 200 is followed from step 202 through step 210, but the portable communication device 310 is never recovered in step 212. In some such embodiments, the second exemplary method 200 then proceeds to step 110 of the first exemplary method 100 and continues from step 110 in the first exemplary method 100 through step 116.

The subject matter described herein improves upon methods where all data on the portable communication device 310 is erased when triggered by a security need or security event, including such erasure without prompting the portable communication device 310. The subject matter described herein also improves upon a method where an owner of the portable communication device 310 sends a short message to the device 310 to trigger complete data erasure from the device 310 and a resetting of the device 310. It is preferable that the message be authenticated. This is comparable, and offers similar improvement over, methods where a “kill pill” command is sent directly to the device 310 in order to wipe all data from the device 310.

It should also be apparent that the subject matter described herein improves upon methods where confidential or sensitive data from the portable communication device 310 is protected at the operating system (OS) or hardware level, including methods that constantly encrypt data, and including methods that use the same key for both encryption and decryption.

It should be noted that in situations where a theft of a portable communication device 310 was intentional and with the purpose of obtaining unauthorized access to confidential or sensitive data stored thereon, local encryption of that data on the portable communication device 310 can often be overcome eventually by advanced and brute force methods because of the adversary's unlimited physical access to the portable communication device 310. Thus, embodiments that include step 114 overcome this problem by destroying the data from the portable communication device 310.

Embodiments of the subject matter described herein that include step 214 improve upon embodiments where confidential or sensitive data on the portable communication device 310 is rendered unavailable to an adversary through total destruction because the data can be recovered through decryption using a private key. The subject matter described herein also improves on embodiments where recovery of OS personalized setting and data backed up on a server is an extensive and labor consuming process. The subject matter described herein also improves on embodiments where confidential or sensitive data is regularly backed up by communications through the communication network 320. This is achieved by reducing the bandwidth necessary to protect that data.

Although the various exemplary embodiments have been described in detail with particular reference to certain exemplary aspects thereof, it should be understood that the invention is capable of other different embodiments, and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only, and do not in any way limit the invention, which is defined only by the claims.

What is claimed is:

1. A method for providing data availability for a portable communication device, comprising:
notifying an operator that the portable communication device is missing;
sending a data retrieval command to the portable communication device;
authenticating the data retrieval command;
retrieving data from the portable communication device;
identifying a portion of the data retrieved from the portable communication device that is confidential; and
erasing the identified confidential data from the portable communication device.

2. The method for providing data availability for a portable communication device, according to claim 1, wherein the portable communication device is lost.

3. The method for providing data availability for a portable communication device, according to claim 1, wherein the portable communication device is stolen.

4. The method for providing data availability for a portable communication device, according to claim 1, wherein erasing the identified confidential data from the portable communication device comprises totally eliminating the data from the portable communication device.

5. The method for providing data availability for a portable communication device, according to claim 1, wherein erasing the identified confidential data from the portable communication device comprises corrupting the data on the portable communication device.

6. The method for providing data availability for a portable communication device, according to claim 1, wherein the portable communication device is selected from the list consisting of a smart telephone, a personal data assistant, and a laptop computer.

7. The method for providing data availability for a portable communication device, according to claim 1, wherein retrieving the data includes encrypting the data.

8. The method for providing data availability for a portable communication device, according to claim 7, wherein encrypting the data is performed using a public key stored on the portable communication device.

9. The method for providing data availability for a portable communication device, according to claim 7, wherein retrieving the data further comprises decrypting the data.

10. The method for providing data availability for a portable communication device, according to claim 9, wherein decrypting the data is performed using a private key stored at a location of the operator.

11. The method for providing data availability for a portable communication device, according to claim 1, wherein the portable communication device includes an operating system.

12. The method for providing data availability for a portable communication device, according to claim 1, wherein the identified confidential data is stored on removable data storage media.

13. The method for providing data availability for a portable communication device, according to claim 1, wherein authenticating the data retrieval command is performed using a secret shared by the operator and an owner of the portable communication device.

14. A method for providing data availability for a portable communication device, comprising:
notifying an operator that the portable communication device is missing;
sending a data retrieval command;
authenticating the data retrieval command;
triggering encryption of data on the portable communication device;
identifying confidential data on the portable communication device;
encrypting the identified confidential data on the portable communication device;
recovering the portable communication device; and
decrypting the confidential data on the portable communication device.

15. The method for providing data availability for a portable communication device, according to claim 14, wherein the data is encrypted using a public key stored on the portable communication device.

16. The method for providing data availability for a portable communication device, according to claim 14, wherein the data is decrypted using a private key stored at a location of the operator.

17. The method for providing data availability for a portable communication device, according to claim 16, wherein the data is encrypted using a public key, and the private key and the public key are a matched pair.

18. The method for providing data availability for a portable communication device, according to claim 17, wherein the matched pair is unique for a defined set of users.

19. The method for providing data availability for a portable communication device, according to claim 14, further comprising identifying that a trigger used for triggering encryption of data on the portable communication device is an external trigger and authenticating the external trigger.

20. A method for providing data availability for a portable communication device, comprising:
notifying an operator that the portable communication device is missing;
triggering encryption of data on the portable communication device;
identifying confidential data on the portable communication device;
encrypting the identified confidential data on the portable communication device;
retrieving the identified confidential data from the portable communication device; and
erasing the identified confidential data from the portable communication device.

21. A system for providing data availability for a portable communication device, comprising:
a means for notifying an operator that the portable communication device is missing;
a means for triggering encryption of data on the portable communication device;
a means for identifying confidential data on the portable communication device;
a means for encrypting the identified confidential data on the portable communication device; and
a means for decrypting the identified confidential data on the portable communication device.
